(19) United States
(12) Patent Application Publication
(10) Pub. No.: US 2011/0058659 A1
(43) Pub. Date: Mar. 10, 2011

(54) Emergency communications system

(76) Inventor: Joseph M. Merlino, Santa Fe, NM (US)

(21) Appl. No.: 12/584,675

(22) Filed: Sep. 10, 2009

(51) Int. Cl. H04M 11/04

(52) U.S. Cl. 379/45

(57) ABSTRACT

Emergency communications system with a master data storage and retrieval center, a subscriber data base, a software program that stores contact information of subscribers and links the contact information with predetermined additional subscribers for automatic sending and receiving during an emergency situation, and the software program including connection to and use of telephone, cell phone, email, SMS text messaging, fax, Internet web, micro blog and other electronic messaging devices. A preferred embodiment includes the subscribers pay into the emergency communications system service and provide user account information.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Provisional Patent Application number 6109134

### BACKGROUND OF THE INVENTION

This invention relates generally to the field of emergency communications systems and more specifically to an emergency communications system where individuals can electively subscribe to which uses a plurality of communications platforms for transmitting messages.

In times of emergency, it is a natural desire for groups of individuals, whether it be only two persons, or a large group of affiliated persons, to be able to contact each other and provide vital information such as state of well being, and location. Others have developed and patented, or applied for patents for group communication methods including patent application numbers:

### US2002/0120698

### US2004/0203562

### US2005/0148317

### US2005/0151642

### US2005/0201528

### US2005/0271048

### US2005/0273330

### US2006/0049934

### US2006/006645

### US2006/0120516

### US2006/0160522

### US2007/0105528

### US2007/0054688

### US2007/0103317

### US2007/0173224

### US2007/0210910

### US2007/0216572

### US2008/0010674

### US2008/0194224

### US2008/0224884

However, there is a deficiency in the prior technology in that none of the prior art shows an emergency communications system that provide effective member to member individualized communication to all members of pre-determined groups of subscribers via all known means of electronic communication simultaneously.

### BRIEF SUMMARY OF THE INVENTION

The primary object of the invention is to provide an emergency communications system that allows individuals or groups of users to electively subscribe to a service allowing the user to employ a plurality of communications platforms for transmitting messages.

Another object of the invention is to provide an emergency communications system that can use one or all communications platforms including voice messaging, test messaging, fax and or e-mail.

Another object of the invention is to provide an emergency communications system whose subscribers can choose to link to one another so that in an emergency, pre-identified user groups can be sent custom designed emergency information.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed emergency communications system comprising: a master data storage and retrieval center, a subscriber data base, a software program that stores contact information of subscribers and links said contact information with predetermined additional subscribers for automatic sending and receiving during an emergency situation, and said software program including connection means to and use of telephone, cell phone, email, sms text messaging, fax, Internet web, micro blog and other electronic messaging devices.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic drawing showing the creation of a user group for an emergency communications system of the present invention.

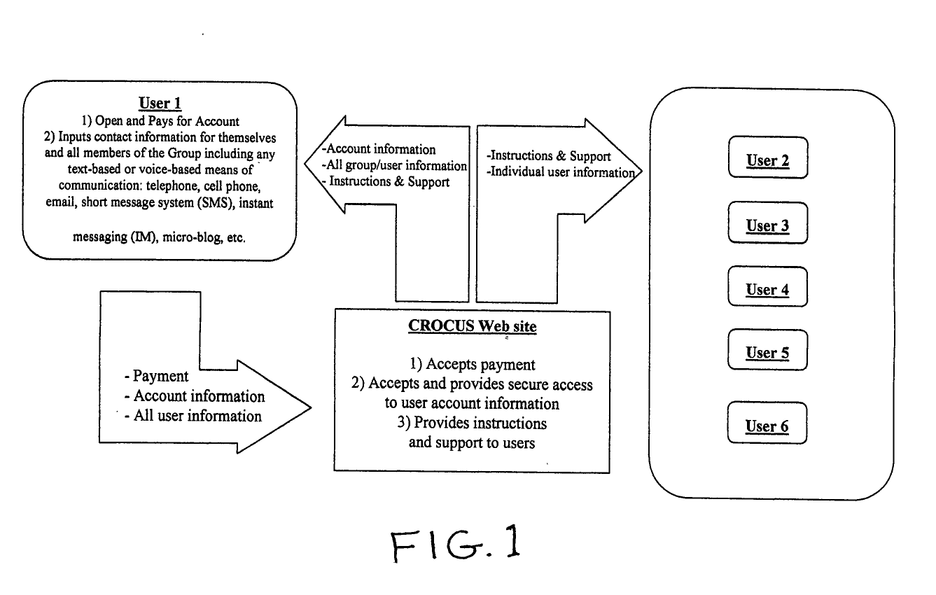

FIG. 2 is a schematic drawing showing the use of the emergency communications system of the present invention.

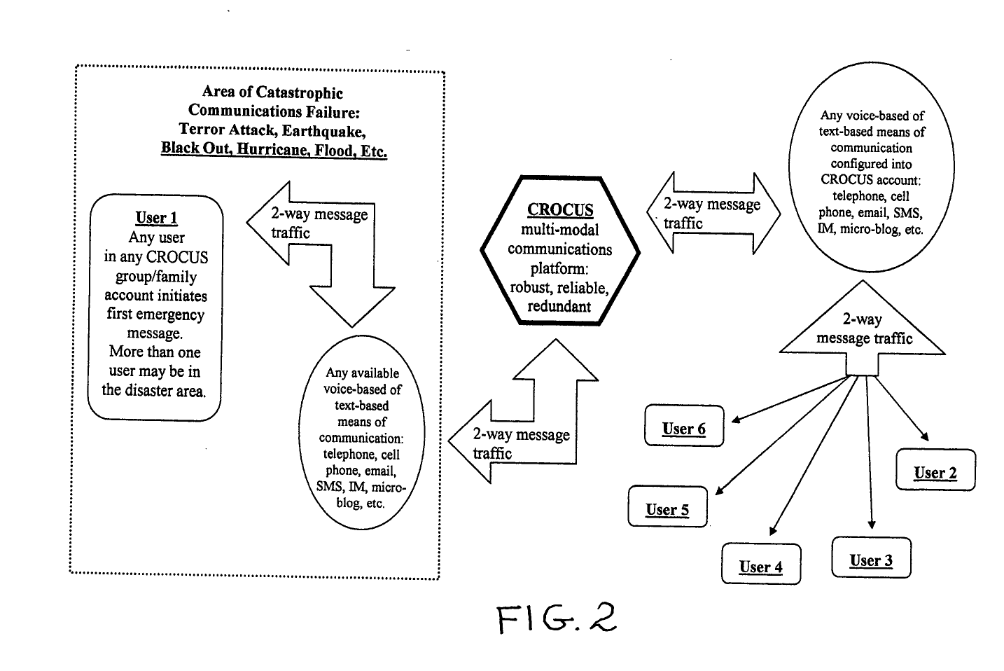

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

As used throughout this application, the term “emergency communications system” is used to refer to one or more embodiments of the emergency communications system of the present invention.

Referring now to the Figs., an embodiment of the present invention relates to an emergency communications system, particularly one which uses multiple communication platforms, which can include, voice messaging, text messaging, fax and/or e-mail.

In one embodiment, the present invention comprises software which comprises computer-executable code stored on a computer-readable medium. In one embodiment a user, or group of users, for example an immediate family, preferably provide contact information for multiple communication platforms (for example, home phone numbers, work phone numbers, cellular telephone numbers, and/or e-mail addresses) to an emergency communications service provider. The user, or group of users, also preferably pays one or more service fees, which can comprise an initial set-up fee, and/or periodically recurring fees (such as monthly, quarterly, semiannually, or annually). In one embodiment, a user name and/or account number is preferably provided to the users of the system, thus providing the users with the ability to have their information associated with a uniquely user-specific identifier. Additional information is preferably provided by the user, which can include names or user-specific identifiers for one or more other system subscribers, thus providing the ability for the emergency communications system provider to link or otherwise associate two or more user accounts.

In the event of an emergency, including but not limited to a natural disaster, the communications service provider preferably enables the users of the system the ability to contact other users, particularly those users to whom the user's account is linked. For example, the service provider preferably has a voice messaging system with which a first user can call the communications service provider's phone number and leave a voice message which can be accessed by and/or distributed to other members, particularly those other members whose accounts are linked therewith.

The emergency communications system preferably enables rapid and reliable messaging across multiple conventional communications platforms, by voice, and by text among a pre-determined group of individuals. The emergency communications system's multimedia technology provides a simple, affordable way for people, especially families, to send and receive messages during a critical event. When conventional means of communication may be disabled or unavailable, such as in the case of major terrorist attacks, massive electrical failures and natural disasters, the emergency communications system preferably comprises backup-power and/or other redundant systems such that the emergency communications system continues to operate.

In one embodiment, users preferably configure their emergency communications system accounts by entering contact information for all the members of their user group (for example a family) at an emergency communications system web site: phone numbers at multiple locations, email addresses, cell phone numbers, text pager numbers, short message system (SMS) contacts, etc. Alternatively, a user can provide the unique identifier of another emergency communications system user, which already has that user's contact information entered.

During an emergency, any member of the user group can preferably send a message to the emergency communications system via any conventional means of communications—telephone, cell phone, satellite phone, instant messaging, SMS text messaging, fax, email, web—and the emergency communications system forwards the message to every member of the group using every configured contact method, automatically converting between text and speech and message formats as necessary.

In each of the recent catastrophic emergencies resulting in massive communications failure, a small number of systems continued to operate. In one embodiment, the emergency communications system is device agnostic and service agnostic. Accordingly, the emergency communications system users can effectively utilize any functioning voice or text communications system within reach. Even in a hypothetical scenario in which all communications failed for a period of time, the emergency communications system users would still have a decisive advantage since they would be able to utilize the first available voice or text communications system(s) to be restored during the recovery period.

Users are preferably encouraged to test their configurations and keep them up to date.

### INDUSTRIAL APPLICABILITY

The invention is further illustrated by the following hypothetical non-limiting example.

### Example 1

This hypothetical scenario describes the use of the emergency communications system by one emergency communications system user group of six individual users (User 1-User 6) during a crisis in which conventional means of communications are disrupted or unavailable.

User 1 is on a business trip in a major US city and finds User 1 in the midst of a catastrophic emergency such as a major terrorist attack, earthquake, hurricane, electrical blackout, etc. User 1 is unaware of the fact that one of User 1′ adult daughters (User 3) is also visiting the same city and has been injured in the emergency.

Immediately following the first phase of the emergency, User 1 is in a large group of people who have followed the instructions of emergency services personnel to gathered in a public park and await further instructions as the emergency progresses.

User 1 sends initial emergency message at 10:30 AM. User 1's regular cell phone service has been disrupted so User 1 cannot contact User 1's family to tell them where User 1 is and that User 1 has not been harmed.

Using User 1's emergency communications system account information that User 1 keeps in User 1's wallet at all times, User 1 places a call to the emergency communications system by means of a nearby public pay phone that is functioning properly. There are more than 50 people waiting to use this same pay phone to place emergency calls to loved ones, so individuals are allowed just one call.

User 1's pay phone call connects to an emergency communications system Internet telecommunications server located in one of numerous secure network server facilities that support the emergency communications system servers all day every day (24/7/365) across the United States. User 1 is prompted by the emergency communications system to leave a voice message on the server. User 1 leaves a voice message stating User 1's location, User 1's status as unharmed, the fact that there has been a catastrophic emergency and that User 1 will leave another message when he learns more about the situation.

The emergency communications system's voice service distributes User 1's voice message to all the voice clients in User 1's emergency communications system user group.

As User 1's voice message is relayed to User 1's emergency communications system user group's voice clients, recipients who accept the call can hear User 1's voice message directly. The user group's voice clients who do not accept this initial call from the emergency communications system voice service, User 1's voice message is deposited into the voice mailbox for each of these voice clients. The emergency communications system voice service will continue to dial the voice clients in User 1's user group until all such voice clients have received User 1's voice message. The emergency communications system voice service also sends User 1's original voice message to the emergency communications system voice to text service for conversion from a voice message into a text message (User 1's text message).

The emergency communications system voice to text service distributes User 1's text message to the emergency communications system email service, the emergency communications system SMS Service, the emergency communications system's fax service and the emergency communications system web service.

The emergency communications system's email service distributes User 1's text message in the form of an email to all the email clients in User 1's emergency communications system user group. The emergency communications system's email service will continue to send User 1's email message to the email clients in User 1's user group until all such email clients have received User 1's email message.

The emergency communications system's SMS Service, via the emergency communications system's SMS gateway distributes User 1's text message in the form of a SMS text message to all the SMS clients and text message clients in User 1's emergency communications system user group. The emergency communications system SMS service will continue to send User 1's text message to all the SMS clients and text message clients in User 1's user group until all such SMS clients and text message clients have received User 1's text message.

The emergency communications system fax service distributes User 1's text message in the form of a fax message to all the fax clients in User 1's emergency communications system user group. The emergency communications system's fax service will continue to dial the fax clients in User 1's user group until all such fax clients have received User 1's fax message.

The emergency communications system's web service distributes User 1's text message to all the web clients in User 1's emergency communications system user group. The emergency communications system's web service will continue to send User 1's text message to the web clients in User 1's user group until all such web clients have received User 1's text message.

Users 2, 4, 5 and 6 receive and respond to User 1's initial emergency message. Users 2, 4, and 5 receive calls from the emergency communications system on their cell phones at 10:32 AM and listen to User 1's initial voice message describing User 1's situation in the catastrophic emergency. Users 2, 4 and 5 each call the emergency communications system themselves to leave voice messages indicating they have received User 1's message, are relieved to hear User 1 is OK and look forward to hearing from User 1 again soon. The emergency communications system's voice service sends the voice messages from Users 2, 4, and 5 to the emergency communications system's voice to text service for conversion from voice messages into text messages. The emergency communications system's voice to text service distributes these text messages to the emergency communications system's email service, the emergency communications system's SMS service, the emergency communications system's fax service and the emergency communications system's web service.

The emergency communications system email service distributes these text messages, from Users 2, 4 and 5, in the form of email messages to all the email clients in emergency communications system user group.

The emergency communications system's SMS Service, via the emergency communications system SMS Gateway distributes these text messages in the form of SMS text messages to all the SMS clients and text message clients in the emergency communications system user group.

The emergency communications system's fax service distributes these text messages in the form of fax messages to all the fax clients in the emergency communications system user group.

The emergency communications system web service distributes these text messages to all the web clients in the emergency communications system user group.

User 6 receives an email message from the emergency communications system on User 6's laptop computer at 10:33 AM relaying User 1's initial emergency message. User 6 sends an email response to the emergency communications system indicating User 6 has received User 1's message and is relieved to hear he is OK. The emergency communications system's email service distributes User 6's email message to all email clients in his emergency communications system user group. The emergency communications system's email service also sends User 6's email message to the emergency communications system's SMS service, the emergency communications system's fax service, the emergency communications system's web service and the emergency communications system's text to voice service.

The emergency communications system's SMS service, via the emergency communications system's SMS gateway, distributes User 6's email message in the form of a SMS text message to all the SMS clients and text message clients in User 6's emergency communications system user group.

The emergency communications system's fax service distributes User 6's email message in the form of a fax message to all the Fax Clients in User 6's emergency communications system user group.

The emergency communications system's web service distributes User 6's text message to all the web clients in User 6's emergency communications system user group.

The emergency communications system's text to voice service converts User 6's email message into a voice message. The emergency communications system's text to voice service sends User 6's converted voice message to the emergency communications system's voice service. The emergency communications system's voice service distributes User 6's converted voice message to all the voice clients in User 6's emergency communications system user group.

By 10:33 AM, Users 2, 4, 5 and 6 are aware of User 1's situation in the emergency and have acknowledged their receipt of User 1's initial emergency message.

User 3 sends her initial emergency message at 11:45 AM. User 3 has been seriously injured in the first phase of the emergency. User 3 has regained consciousness among hundreds of casualties being treated in a temporary first aid station established by emergency services personnel in an inner city rail station. User 3 has no personal effects other than User 3's wallet.

User 3 asks a nearby first aid worker if User 3 can send a message to User 3's family using the first aid worker's mobile email device (e.g. Blackberry, etc.). The first aid worker is extremely busy and under significant stress, but agrees to help User 3 send one email message. User 3 provides the first aid worker with the emergency communications system's email contact information found on her emergency communications system account information card she keeps in her wallet at all times. The first aid worker follows the emergency communications system instructions User 3 provides to him and sends an email to User 3's emergency communications system emergency email address stating that User 3 has been injured in a catastrophic emergency and User 3's location at the first aid station. User 3's email message arrives at an emergency communications system Internet telecommunications server.

The emergency communications system's email service identifies User 3's inbound email message by its destination email address. The emergency communications system's email service extracts the content of User 3's inbound email message and creates a corresponding outbound email message that will originate from User 3's emergency communications system user profile for distribution to all the clients in User 3's emergency communications system user group. The emergency communications system's email service distributes User 3's outbound email message to email clients in User 3's emergency communications system user group. The emergency communications system's email service will continue to send User 3's email message to the email clients in User 3's user group until all such email clients have received User 3's email message. The emergency communications system's email service also sends User 3's outbound email message to the emergency communications system's SMS service, the emergency communications system's fax service, the emergency communications system's web service and the emergency communications system's text to voice service.

The emergency communications system's SMS service, via the emergency communications system's SMS gateway, distributes User 3's email message in the form of a SMS text message to all the SMS clients and text message clients in User 3's emergency communications system user group.

The emergency communications system's SMS service will continue to send User 3's text message to all the SMS clients and text message clients in User 3's user group until all such SMS clients and text message clients have received User 3's text message.

The emergency communications system's fax service distributes User 3's email message in the form of a fax message to all the fax clients in User 3's emergency communications system user group.

The emergency communications system's fax service will continue to dial the fax clients in User 3's user group until all such fax clients have received User 3's fax message.

The emergency communications system's web service distributes User 3's text message to all the web clients in User 3's emergency communications system user group.

The emergency communications system's web service will continue to send User 3's text message to the web clients in User 3's user group until all such web clients have received User 3's text message.

The emergency communications system's text to voice service converts User 3's email message into a voice message. The emergency communications system's text to voice service sends User 3's converted voice message to the emergency communications system's voice service. The emergency communications system's voice service rapidly distributes User 3's converted voice message to all the voice clients in User 3's emergency communications system user group. As User 3's voice message is relayed to User 3's emergency communications system user group's voice clients, recipients who accept the call can hear User 3's converted voice message directly.

The emergency communications system user group's voice clients who do not accept this initial call from the emergency communications system's voice service, User 3's converted voice message is deposited into the voice mailbox for each of these voice clients. The emergency communications system's voice service will continue to dial the voice clients in User 3's user group until all such voice clients have received User 3's converted voice message.

User 1 checks responses to initial emergency message at 12:15 PM. User 1 has moved from the public park to a downtown shopping mall where emergency services personnel have established a temporary distribution center for water and food.

User 1's regular cell phone service is still disrupted. User 1 observes that emergency services personnel are providing brief periods of Internet access to individuals at an Internet café in the downtown shopping mall. When User 1's turn comes, User 1 accesses an emergency communications system web page that provides access to all User 1's emergency communications system messages in text form. Reviewing User 1's emergency communications system messages, User 1 observes that Users 2, 4, 5 and 6 have received and acknowledged User 1's initial emergency message via emergency communications system. User 1 also sees User 3's initial emergency message indicating that User 3 has been injured and is recovering in a first aid station several blocks from User 1's current location.

Via the same emergency communications system web page, User 1 sends an email message to the emergency communications system that acknowledges User 3's initial emergency message. User 1 also states User 1 will proceed immediately on foot to the first aid station where User 3 is recuperating and will contact the rest of the emergency communications system user group with an update as soon as possible after User 1 arrives at User 3's location. The emergency communications system's email Service distributes User 1's email message to all email clients in the emergency communications system user group. The emergency communications system's email service also sends User 1's email message to the emergency communications system's SMS service, the emergency communications system's fax service, the emergency communications system's web service and the emergency communications system's text to voice service.

The emergency communications system's SMS service, via the emergency communications system's SMS gateway, distributes User 1's email message in the form of a SMS text message to all the SMS clients and text message clients in the emergency communications system user group.

The emergency communications system's fax service distributes User 1's email message in the form of a fax message to all the fax clients in the emergency communications system user group.

The emergency communications system's web service distributes User 1's text message to all the web clients in the emergency communications system user group.

The emergency communications system's text to voice service converts User 1's email message into a voice message. The emergency communications system's text to voice service sends User 1's converted voice message to the emergency communications system's voice service. The emergency communications system's voice service distributes User 1's converted voice message to all the voice clients in the emergency communications system user group.

By 12:17 PM, Users 1, 2, 4, 5 and 6 are fully aware of the status of everyone in their emergency communications system user group. User 1 is on User 1's way to check on the condition of the injured User 3, report User 3's condition to the rest of the emergency communications system user group and provide an update as to how and/or when User 1 and User 3 will be able to leave the site of the emergency for a safer location with conventional communications capability restored.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. emergency communications system comprising:
a master data storage and retrieval center;
a subscriber data base;
a software program that stores contact information of subscribers and links said contact information with predetermined additional subscribers for automatic sending and receiving of messages during an emergency situation; and
said software program including connection means to, and use of telephone, cell phone, email, SMS text messaging, fax, Internet web, micro blog and other standard electronic messaging devices.

2. Emergency communications system as claimed in claim 1 wherein said subscribers pay into said emergency communications system service and provide user account information to said service system.

3. Emergency communications system as claimed in claim 1 wherein said emergency communications system provides instructions and support to said account users.

4. Emergency communications system as claimed in claim 1 wherein, in time of emergency, said emergency communications system can send messages from one account member to another pre-selected account member or group of account members via said connection means simultaneously.

5. Emergency communications system as claimed in claim 1 further comprising an account information card that can be used by said subscriber in times of emergencies to help emergency workers facilitate communication with said pre selected subscriber group
